(19) United States
(12) Patent Application Publication
(10) Pub. No.: US 2026/0235245 A1
(43) Pub. Date: Aug. 13, 2026

(54) Bushing, Control Bar Lock, and Housing for Manually Operated Plugging Machine

(71) Applicant: R.B. Williamson Energy Advisors LLC, Tulsa, OK (US)

(72) Inventors: Joseph Alan Morton, Jenks, OK (US); Richard Brooks Williamson, Tulsa, OK (US); James L. Sweat, Jr., Tulsa, OK (US); Lawrence Dean Alspaugh, Haskell, OK (US); James Newton Kay, Tulsa, OK (US); Robert Bockmeulen, Tulsa, OK (US)

(21) Appl. No.: 19/535,849

(22) Filed: Feb. 10, 2026

Related U.S. Application Data
(60) Provisional application No. 63/813,756, filed on May 29, 2025.
(60) Provisional application No. 63/756,638, filed on Feb. 10, 2025.

(51) Int. Cl. F16L 47/34

(52) U.S. Cl. CPC F16L 47/34

(57) ABSTRACT

Control bar locks of this disclosure are adapted for use with manually operated plugging machines like those used in oil and gas pipeline maintenance and repair. When in a locked state, the lock restricts and prevents lateral and longitudinal movement of the plugging machine’s control bar. In some embodiments, a bushing functions as the control bar lock. In other embodiments, a cap functions as the lock. The bushing eliminates the need to remove and replace the O-ring seal used in prior art housings; instead, the bushing contains the seal. The cap helps ensure the plugging head is in its final sealing position within the pipe as the cap’s geometry about the control bar prevents its connection to the housing when the control bar is moving the plugging head into the final sealing position.

### CROSS-REFERENCE TO CO-PENDING APPLICATIONS

This application claims priority to, and the benefit of, US 63/756,638 filed 02/10/2025 and US 63/813,756 filed 05/29/2025, the subject matter of each incorporated herein by reference.

### BACKGROUND

This disclosure is in the field of manually operated plugging machines that are inserted through a tapped opening in a sidewall of a pipe and into a pressurized interior of a pipeline during hot tapping and plugging operations.

Manually operated plugging machines include a pressure-containing housing connected to a tapping valve which, in turn, provides access through a sidewall opening to a pressurized interior of a pipeline. A control bar, which extends from a top end of the housing, is connected to a plugging head. The control bar lowers the plugging head through the tapping valve and into the interior of the pipeline and then moves the head laterally along the pipeline to a seated or sealed position to one side of the sidewall opening. An O-ring, which resides in a machined gland located toward the top end of the housing, helps seal the control bar within the housing as the control bar lowers the plugging head and moves it laterally into the sealed position (and when raising it after pipeline maintenance and repair operations are completed).

Once the plugging head is set, if the control bar is bumped or jarred by pipeline personnel or by a piece of equipment, the plugging head can become dislodged and the control bar can pop upwards and out of the housing at significant force, thereby posing a safety hazard to nearby pipeline personnel or bystanders.

Additionally, the O-ring must be maintained and replaced from time-to-time. When removing the O-ring for inspection or replacement, the gland can become damaged.

### SUMMARY

Embodiments of a control bar lock of this disclosure are adapted for connection to an upper end of a housing of a manual plugging machine and, when in a locked state, restrict lateral and longitudinal movement of the plugging machine’s control bar. In some embodiments, a bushing functions as the control bar lock. In other embodiments, a cap functions as the lock.

The bushing eliminates the need to remove and replace the O-ring seal used in prior art housings; instead, the bushing contains the seal. The cap helps ensure the plugging head is in its final sealing position within the pipe as the cap’s geometry about the control bar prevents its connection to the housing when the control bar is moving the plugging head into the final sealing position.

A housing of this disclosure, which may include the control bar lock, may include handles to assist in handling and positioning the plugging machine onto an access fitting and valve to the pipe interior, as well as assisting with rotation and connection of the housing to the valve.

Embodiments of a bushing of this disclosure are adapted for threaded connection to an upper end of a housing of a manually operated plugging machine. The threaded connection may be to a locking ring of the housing. The bushing includes a central through opening that is sized to receive a control bar of the manually operated plugging machine and, within the central through opening, a circumferential seal residing in a circumferential gland.

The central through opening permits vertical movement of the control bar as well as lateral movement as the control bar moves a plugging head laterally along the pipeline to its seated or sealed position. The central though opening may have the same or a different diameter at its lower or upper end and may taper along portion of its length.

In other embodiments of a bushing of this disclosure, the bushing includes a plurality of laterally oriented through holes arranged toward the upper end of the bushing about a periphery of the bushing, and a corresponding plurality of fasteners adapted for use with the through holes. Each fastener, when in a tightened position in the through hole, contacts a corresponding opposing portion of the control bar. The fasteners may be thumb screws. Collectively, the fasteners prevent movement of the control bar laterally (horizontal direction) or longitudinally (vertical direction).

Embodiments of a cap of this disclosure are adapted for connection to an upper end of a housing of a manually operated plugging machine. The threaded connection may be to a locking ring of the housing. The cap includes a through hole that is offset and angled relative to the hole of the housing. The offset, angled through hole receives the control bar and can only be connected to the housing when the control bar is in its final set position, meaning the plugging head is in its seated or sealed position.

A housing of this disclosure may include a pair of handles. In some embodiments of this disclosure, the housing does not include the machined gland like that of the prior art and instead includes the bushing, threadably connected at an upper end. The bushing may include the control lock. Or, the housing may include the machined gland and a worn seal, in which event the bushing may be added, thereby eliminating the need to remove the worn seal. In other embodiments, the housing may include the bushing and the cap at its upper end, the cap serving as the control bar lock. In yet other embodiments, the housing includes only the cap, and may include the prior art seal arrangement.

In yet other embodiments of this disclosure, the control bar lock is part of the housing and not part of the bushing.

### DRAWINGS

FIG. 1 is a cross-sectional view of an embodiment of a bushing of this disclosure when connected to an upper end of a housing of a manually operated plugging machine.

FIG. 2 is a perspective view of the bushing of FIG. 1. The bushing may reside within a locking ring of the housing.

FIG. 3 is a cross-sectional view of another embodiment of a bushing of this disclosure that includes locking means for securing a control bar when the control bar – whose full length is not illustrated here -- is in its final set position with the plugging head (not shown) in its seated or sealed position. The secured control bar is prevented from moving laterally (horizontal direction) or longitudinally (vertical direction).

FIG. 4 is a perspective view of the bushing of FIG. 3. The locking means may be a set of thumb screws or the like.

FIG. 5 is a cross-sectional view of an embodiment of a cap of this disclosure when connected to an upper end of a housing of a manually operated plugging machine. The cap includes an offset, angled through hole that receives the control bar and can only be connected to the housing when the control bar is in its final set position. Similar to FIG. 3, the full length of the control bar, as well as the plugging head, is not shown.

FIG. 6 is a perspective view of the cap of FIG. 5. The cap prevents the control bar from moving laterally or longitudinally.

FIG. 7 is a front elevation view of another embodiment of a bushing of this disclosure including handles.

FIG. 8 is a side elevation view thereof.

FIG. 9 is a rear elevation view thereof.

FIG. 10 is a perspective view thereof.

FIG. 11 is a cross-sectional view of yet another embodiment of this disclosure in which the control bar lock is part of the housing and not part of a bushing.

FIG. 12 is a perspective view thereof.

### ELEMENTS AND NUMBERING USED IN THE DRAWINGS AND DESCRIPTION

10 Bushing

11 Central through opening

13 Seal

15 Gland

17 Threads

30 Bushing

31 Central through opening

33 Seal

35 Gland

37 Threads

39 Lateral through holes

41 Fasteners

50 Cap

51 Offset, angled through hole

53 Seal

55 Gland

60 Handles

C Control bar

E Fitting for equalization line or bypass line

H Housing

Hc Control-bar receiving hole or opening

Hu Upper end of housing

R Locking ring

F Fitting for pressure gauge

### DESCRIPTION

Embodiments of this disclosure are adapted for use with a manually operated plugging machine similar to, or the same or substantially the same as, a SHORTSTOPP® 60 plugging machine or the like. A bushing and a cap of this disclosure may be used as part of a new manual plugging machine or to retrofit an existing manual plugging machine.

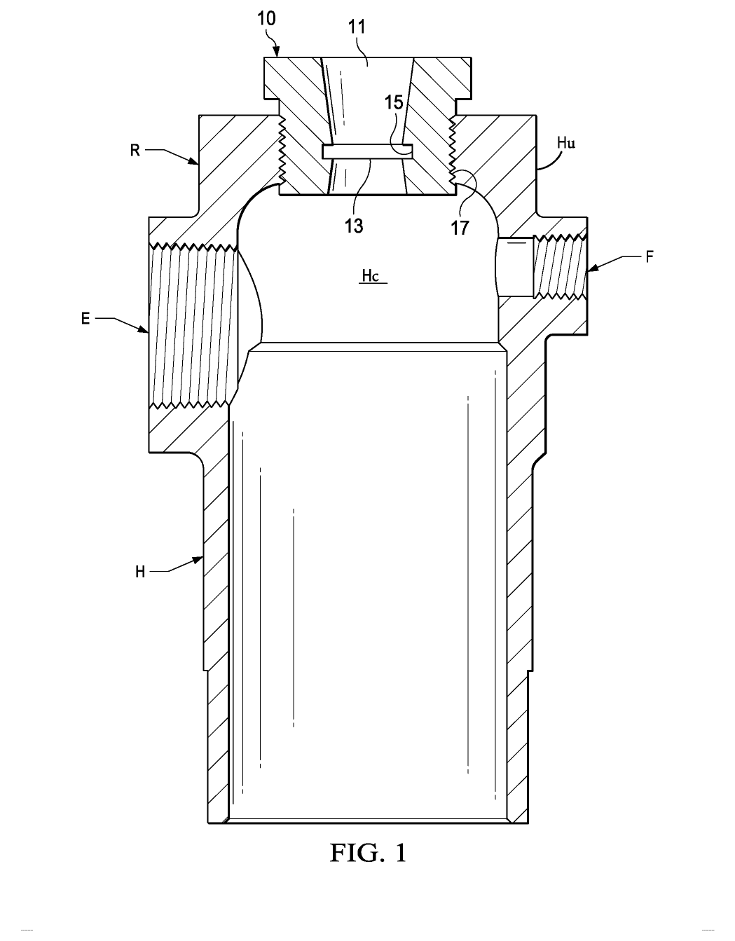

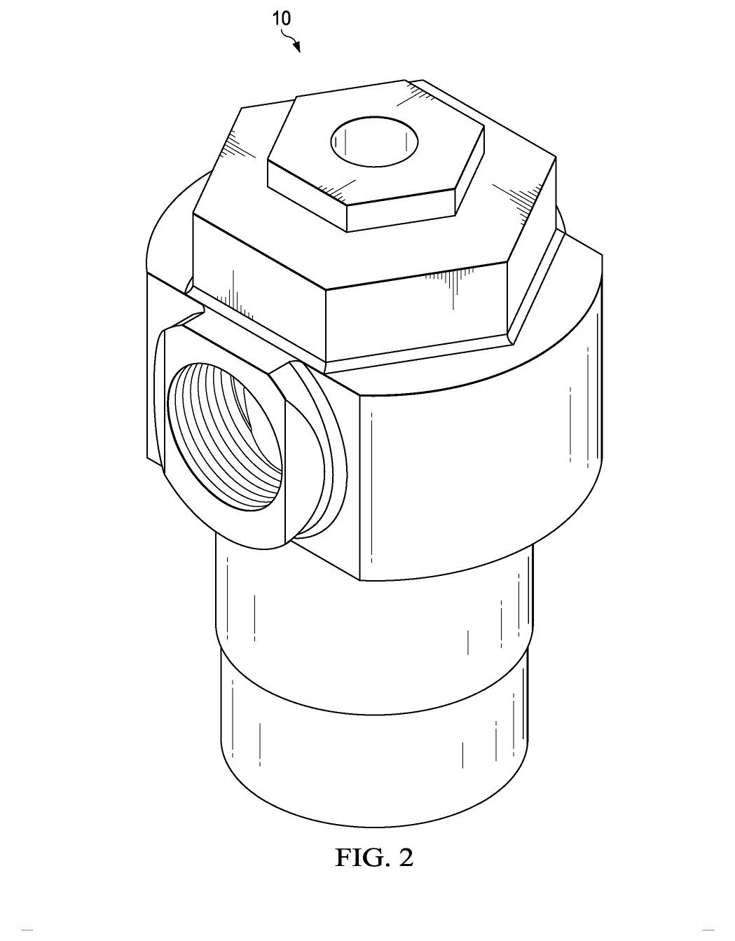

Referring first to FIGS. 1 and 2, in one embodiment of this disclosure, a bushing 10 adapted for threaded connection to a housing H includes a central through opening 11 having a circumferential gland 15 in which a seal 13 resides. The bushing 10, which includes NPT threads 17, can be readily removed and replaced in the field, thereby improving upon the current process of digging out the prior art O-ring seal from the machined gland at the top of the housing when seal replacement is needed.

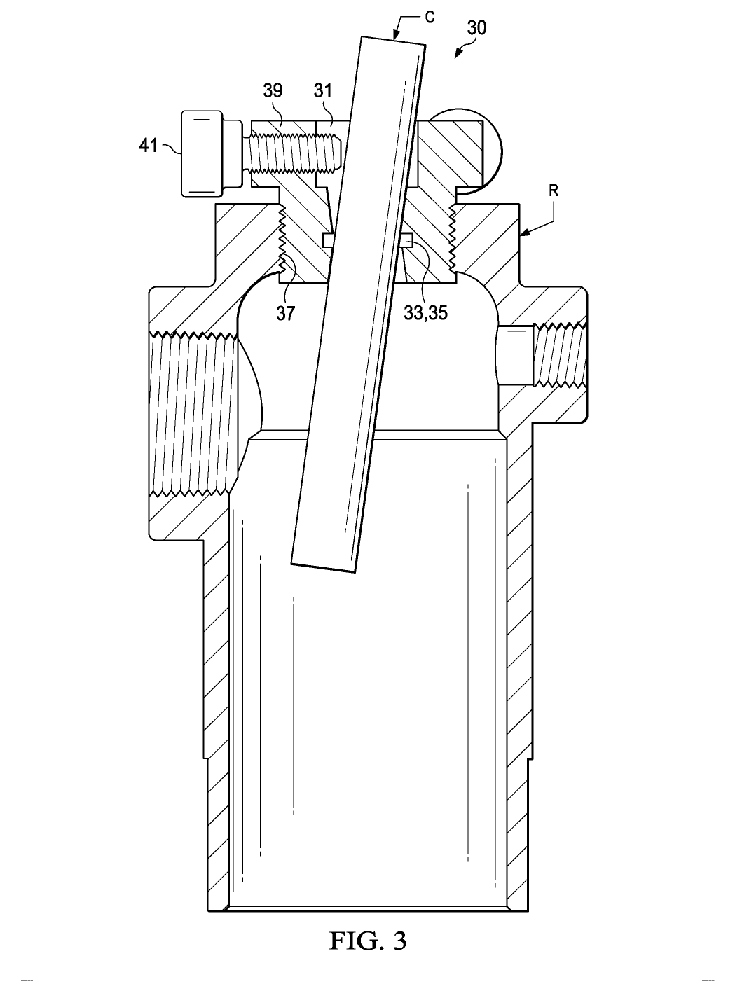

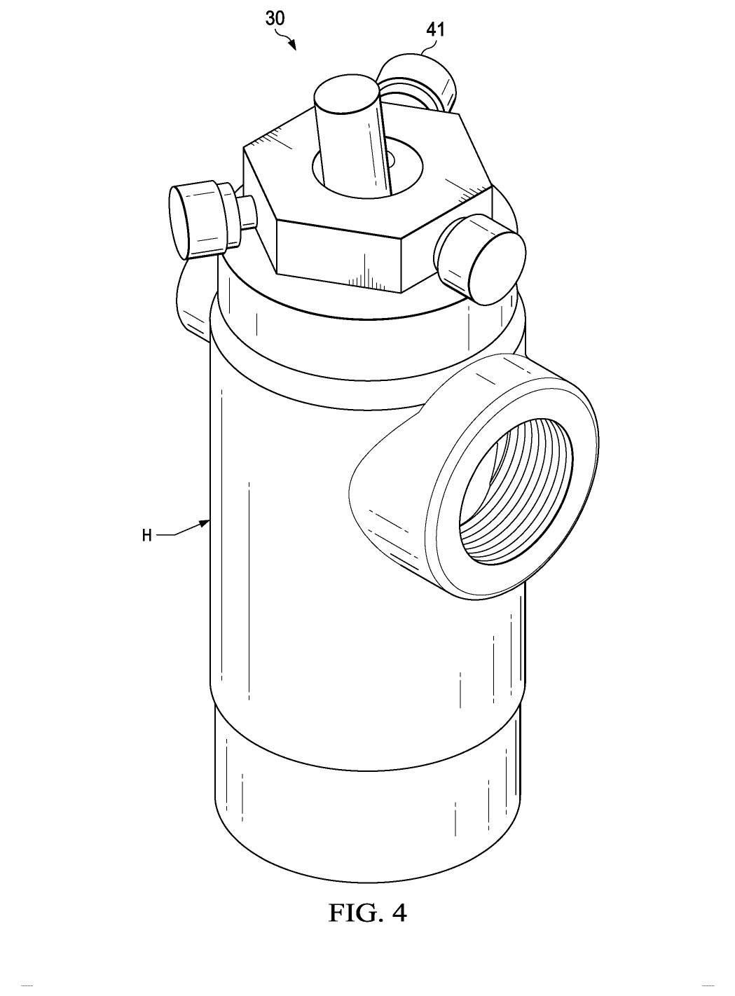

Referring now to FIGS. 3 and 4, in other embodiments of this disclosure a bushing 30, which is extended in height compared to that of bushing 10, includes a lock to secure the control bar C and prevent its unintended retraction or dislodgement. The lock may be in the form of a plurality of fasteners 41 that are received by a corresponding lateral through hole 39 located about the periphery of the bushing 30. The fasteners 41 may be thumb screws that, when tightened after the plugging head is set, contact the control bar C and hold the control bar C and restrict or prevent its movement laterally or longitudinally.

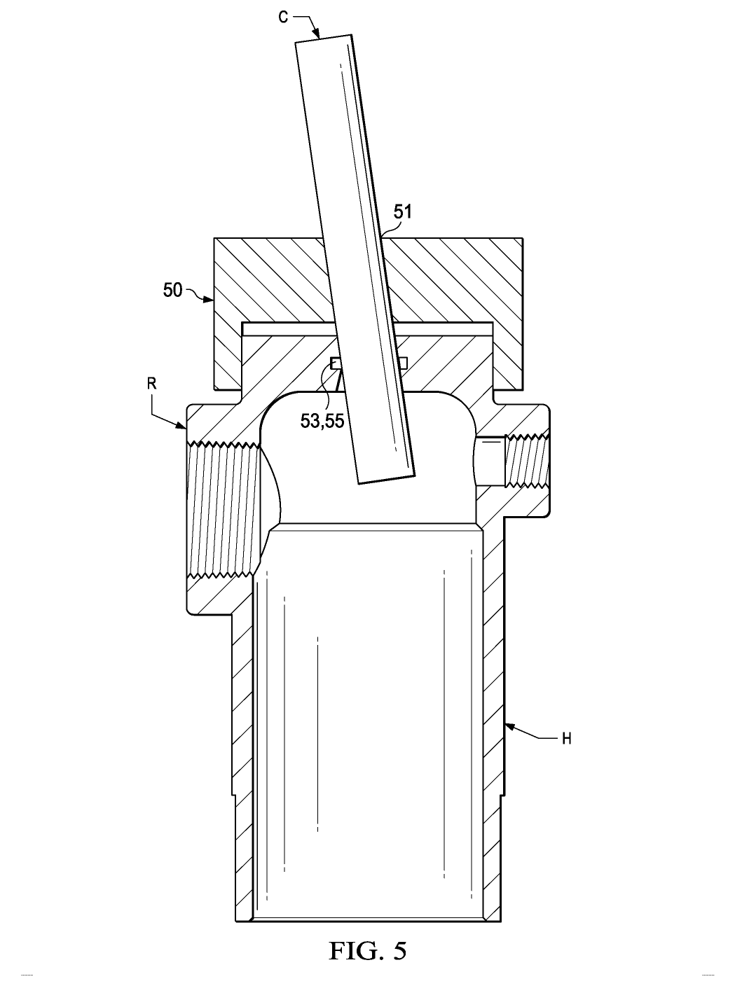

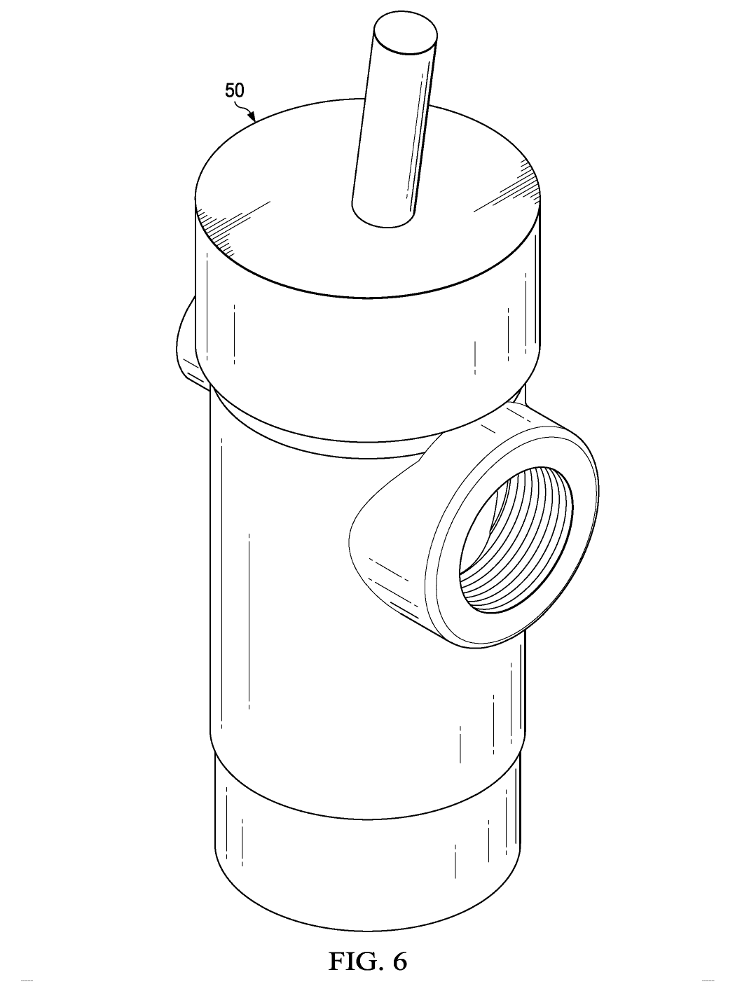

Referring now to FIGS. 5 and 6, in embodiments of this disclosure a cap 50, sized to fit over, and threadably connect to, an upper end of the housing H, includes a through hole 51 that is offset and angled relative to that of a hole of the housing H and receives the control bar C. The cap 50 only fits over, and therefore is connectable to, the housing H if the control bar C is in its proper final position. An O-ring and gland 53, 55 is located below the cap 50.

The offset, angled hole 51 restricts or prevents lateral movement but, by itself, does not limit longitudinal or vertical travel of the control bar C unless the plugging head is properly positioned in the pipe run. The three fasteners 41, when tightened, do prevent vertical bar travel, independent of where the plugging head is located.

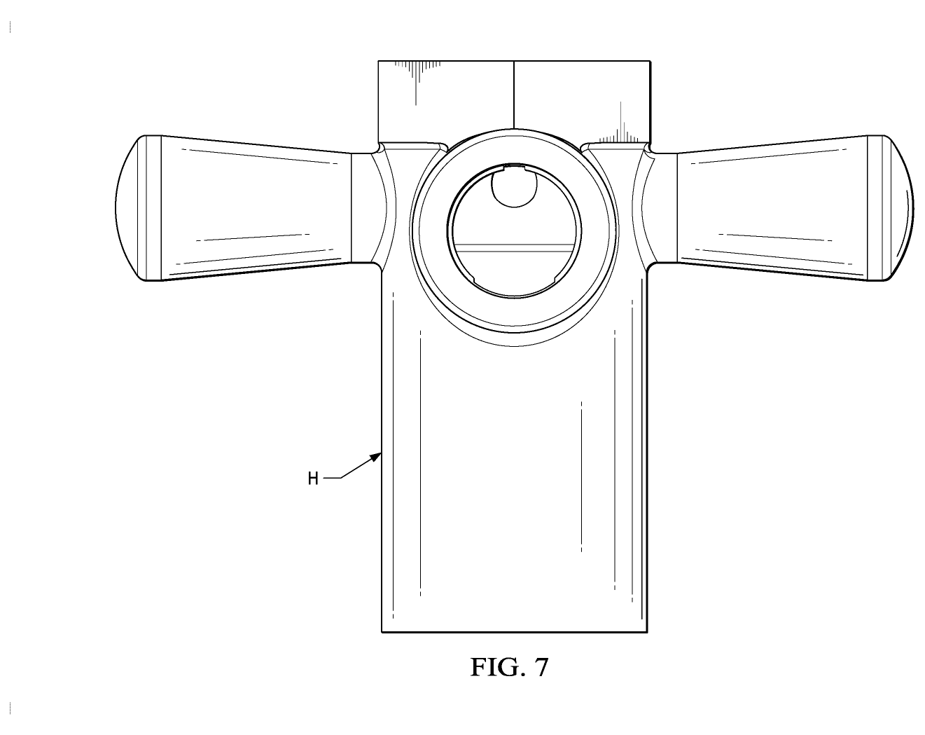

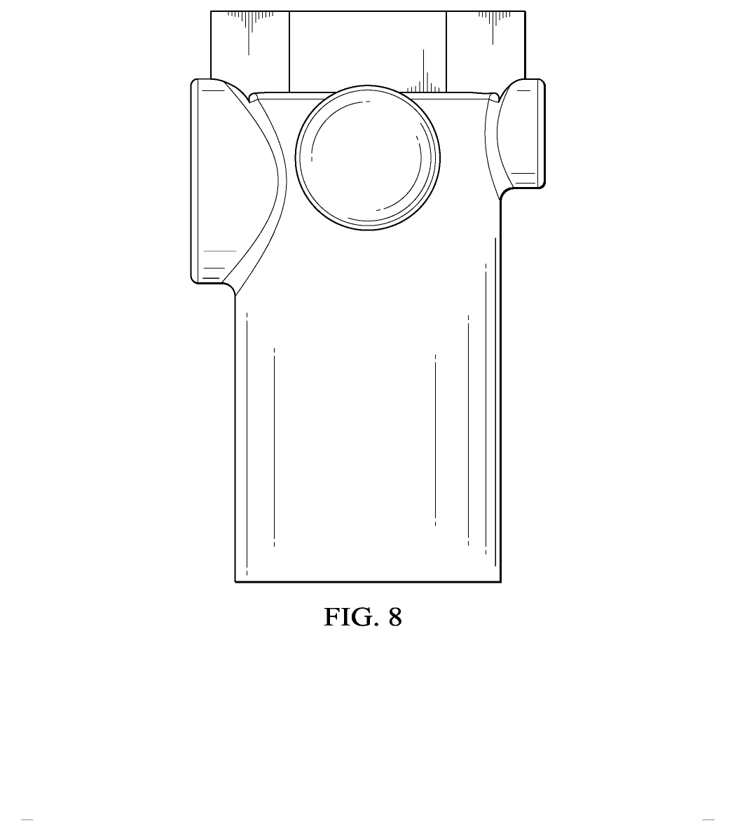

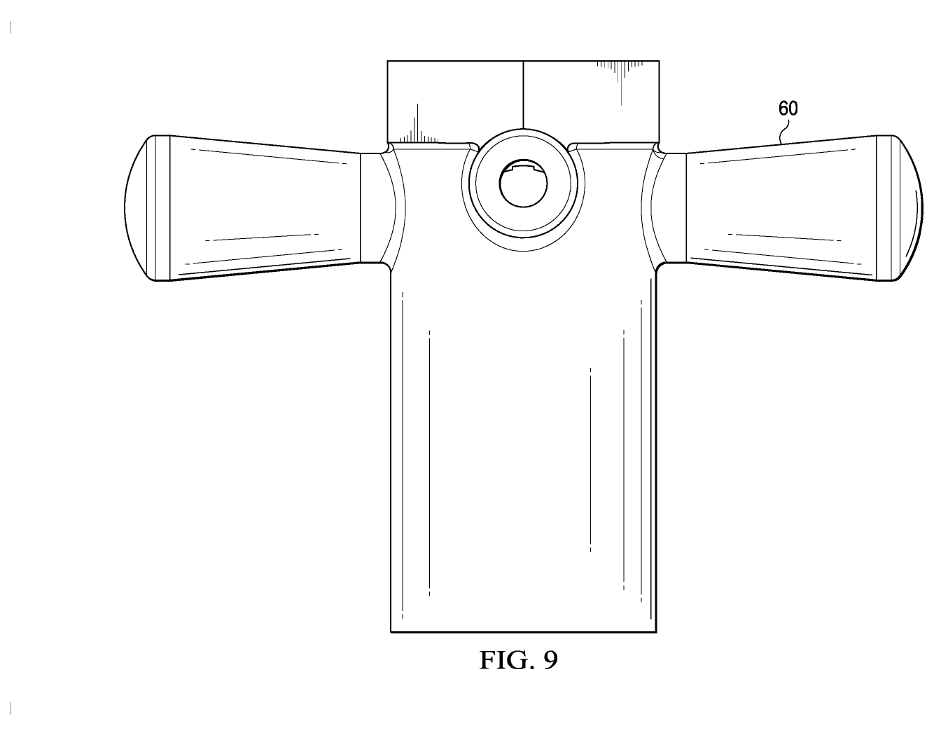

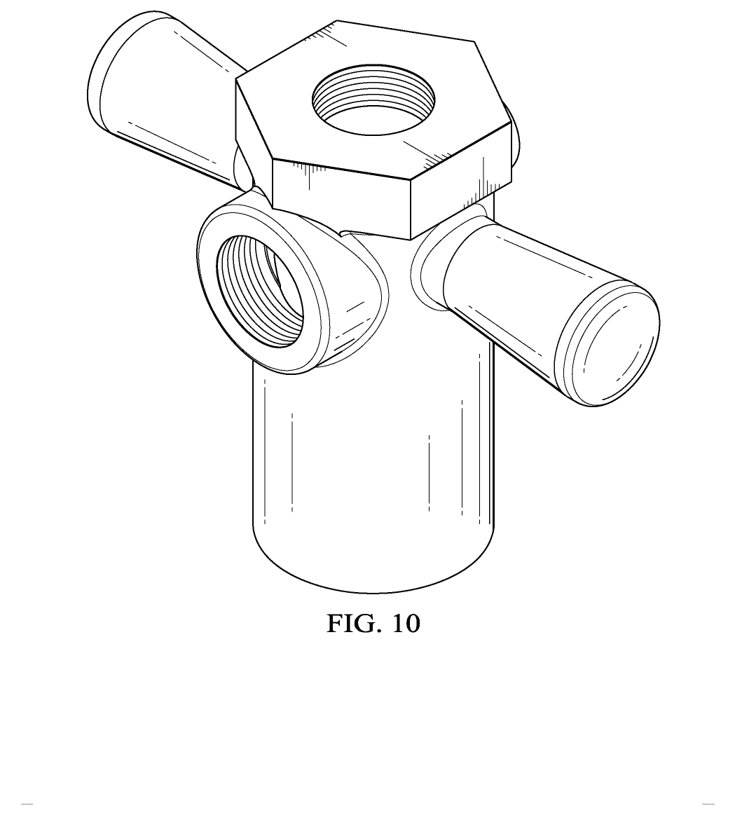

Referring now to FIGS. 7 to 10, the housing H may include handles 60. The handles 60 assist in handling and positioning the housing H as well as tightening of the housing H during assembly. The handles 60 are part of the housing H to reduce the use of common adjustable tools that may damage the exterior of the housing H. In embodiments, the handles 60 are located toward the upper end of the housing H. In other embodiments the handles 60 may be located toward the midline of the housing. The housing H may include a fitting E for an equalization line or bypass line and a fitting F for a pressure gauge.

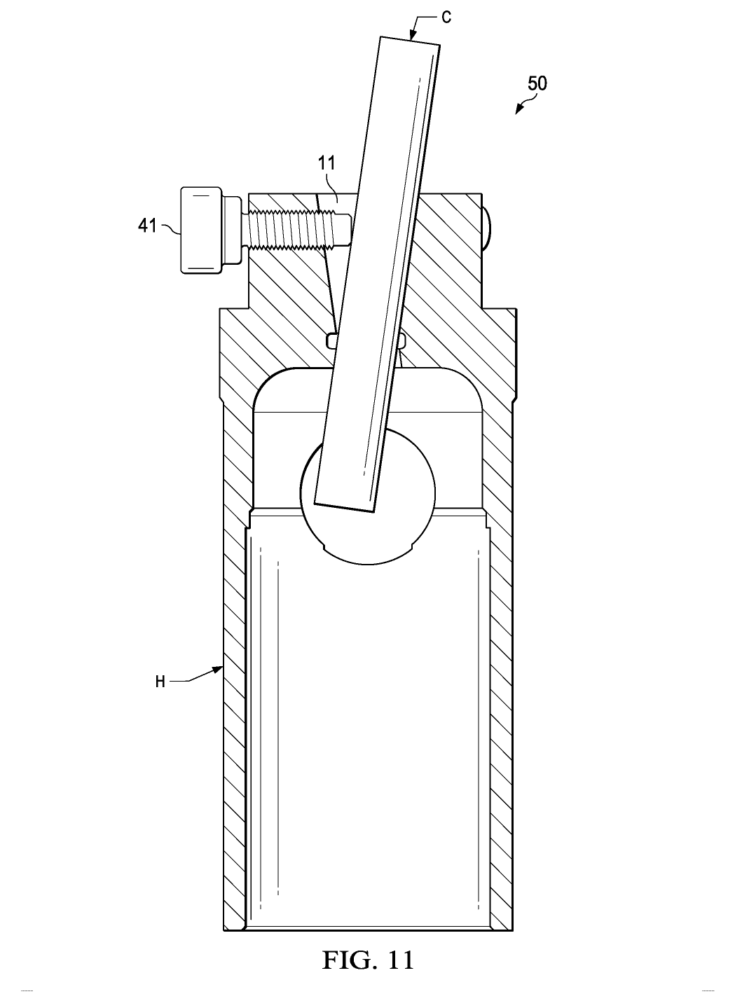

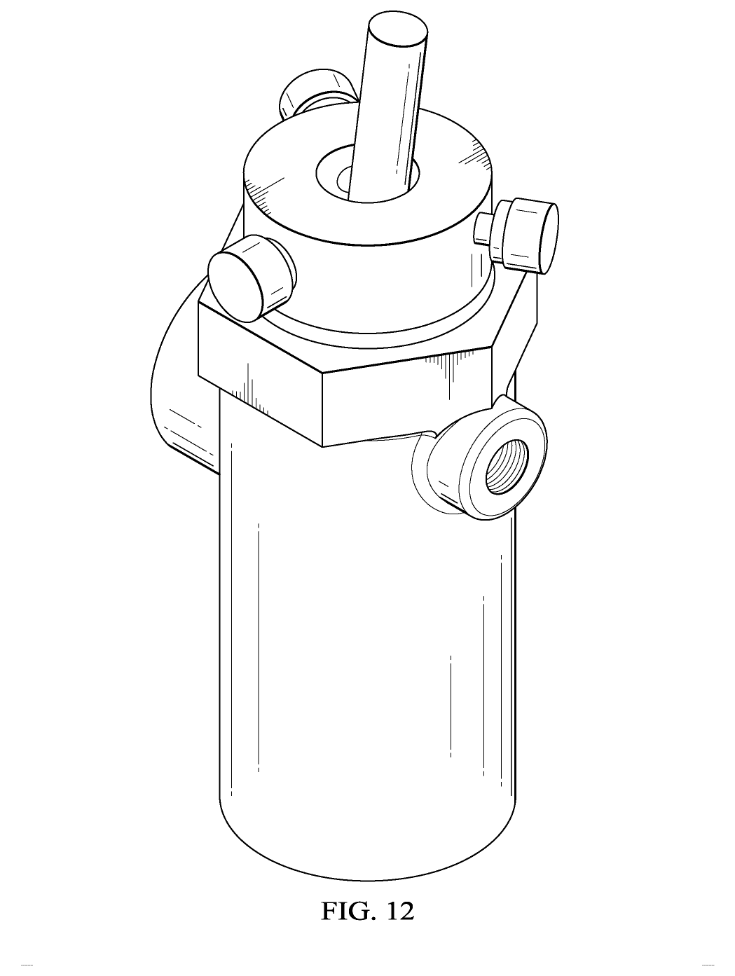

Referring last to FIGS. 11 and 12, in some embodiments of this disclosure, the cap 50 and control bar lock 41 is part of the housing H and not part of a bushing 10, 30 or threadable cap 50.

While embodiments of a control bar lock and housing of this disclosure have been described, persons of skill may make modifications in the details of their design without departing from the scope of the following claims, the recited elements of which are entitled to their full range of equivalents.

1. A control bar lock adapted for use with a housing of a manually operated plugging machine the housing being a pressure-retaining housing, the control bar lock including:
a central through hole sized to receive a portion of a control bar of the manually operated plugging machine;
a plurality of lateral through holes arrayed about a periphery of the control bar lock, the lateral through holes in communication with the central through hole; and
a plurality of fasteners, the fasteners insertable into corresponding ones of the lateral through holes;
wherein the control bar lock resides at an upper end of the housing, and
wherein the control bar lock, when in a locked state, restricts lateral and longitudinal movement of the control bar.

2. The control bar lock of claim 1, wherein the central through hole further comprises a control bar seal.

3. The control bar lock of claim 1, wherein the central through passageway is coaxial with a control bar-receiving hole of the housing.

4. The control bar lock of claim 1, wherein the central through passageway is offset and angled relative to a control bar-receiving hole of the housing.

5. The control bar lock of claim 1, wherein the control bar lock is adapted for threaded connection to the upper end of the housing.

6. The control bar lock of claim 1, wherein the upper end of the housing comprises the control bar lock.

7. The control bar lock of claim 1, wherein the control bar lock further comprises a bushing, the bushing containing the control bar seal.

8. The control bar lock of claim 1, wherein the control bar lock comprises a cap adapted for threaded connection to the upper end of the housing.

9. The control bar lock of claim 1, wherein the upper end of the housing includes a locking ring, at least a portion of the control bar lock residing within the locking ring.

10. The control bar lock of claim 1, wherein the central through hole is cylindrical shaped along at least a portion of its length.

11. The control bar lock of claim 1, wherein the central through hole is tapered along a least a portion of its length.

12. The control bar lock of claim 1, wherein the central through hole includes at least two different diameters along its length.

13. The control bar lock of claim 1, wherein the fasteners include thumb screws.

14. The control bar lock of claim 1, wherein the housing further comprises a pair of handles.

15. A method for re-sealing a control bar of a manually operated plugging machine, the manually operated plugging machine including a housing having a machined gland toward an upper end of the housing and a worn control bar seal located within the machined gland, the method including leaving the worn control bar seal in place and installing the control bar lock of claim 2 at the upper end of the housing having the machined gland.

16. The method of claim 15, wherein the control bar lock further comprises at least one of a bushing and a cap.

17. The method of claim 15, wherein the installing comprises threadably connecting the control bar lock to the upper end of the housing.

18. A method for preventing dislodgement of a control bar of a manually operated plugging machine, the method including:
positioning the control bar lock of claim 1 onto a portion of the control bar extending above an upper end of the housing; and
after the positioning, connecting the control bar lock to the upper end of the housing; and
after the connecting, tightening the fasteners of the control bar lock.

19. The method of claim 17, wherein the central through hole of the control bar lock of claim 1 is offset and angled relative to a control bar-receiving hole of the housing, and wherein the control bar lock is only connectable to the upper end of the housing when the control bar has positioned a plugging head in a sealed or seated position within a pipe; the method further comprising, prior to the connecting, positioning the plugging head in the sealed or seated position, then performing the connecting.
